(19) United States
(12) Patent Application Publication
(10) Pub. No.: US 2009/0248988 A1
(43) Pub. Date: Oct. 1, 2009

(54) MECHANISM FOR MAINTAINING CONSISTENCY OF DATA WRITTEN BY IO DEVICES

(75) Inventors: Thomas Benjamin Berg, Portland, OR (US); William Lee, Portland, OR (US)

Correspondence Address: TOWNSEND AND TOWNSEND AND CREW LLP/MIPS, TWO EMBARCADERO CENTER, 8TH FLOOR, SAN FRANCISCO, CA, 94111, US

(73) Assignee: MIPS Technologies, Inc., Mountain View, CA (US)

(21) Appl. No.: 12/058,117

(22) Filed: Mar. 28, 2008

(51) Int. Cl. G06F 12/00

(52) U.S. Cl. 711/141; 711/E12.001

(57) ABSTRACT

A multi-core microprocessor includes, in part, a cache coherence manager that maintains coherence among the multitude of microprocessor cores, and an I/O coherence unit that maintains coherent traffic between the I/O devices and the multitude of processing cores of the microprocessor. The I/O coherence unit stalls non-coherent I/O write requests until it receives acknowledgement that all pending coherent I/O write requests issued prior to the non-coherence I/O write requests have been made visible to the processing cores. The I/O coherence unit ensures that MMIO read responses are not delivered to the processing cores until after all previous I/O write requests are made visible to the processing cores. Deadlock conditions are prevented by limiting MMIO requests in such a way that they can never block I/O write requests from completing.

### BACKGROUND OF THE INVENTION

The present invention relates to multiprocessor systems, and more particularly to maintaining coherency between an Input/Output device and a multitude of processing units.

Advances in semiconductor fabrication technology have given rise to considerable increases in microprocessor clock speeds. Although the same advances have also resulted in improvements in memory density and access times, the disparity between microprocessor clock speeds and memory access times continues to persist. To reduce latency, often one or more levels of high-speed cache memory are used to hold a subset of the data or instructions that are stored in the main memory. A number of techniques have been developed to increase the likelihood that the data/instructions held in the cache are repeatedly used by the microprocessor.

To improve performance at any given operating frequency, microprocessors with a multitude of cores that execute instructions in parallel have been developed. The cores may be integrated within the same semiconductor die, or may be formed on different semiconductor dies coupled to one another within a package, or a combination of the two. Each core typically includes its own level-1 cache and an optional level-2 cache.

A cache coherency protocol governs the traffic flow between the memory and the caches associated with the cores to ensure coherency between them. For example, the cache coherency protocol ensures that if a copy of a data item is modified in one of the caches, copies of the same data item stored in other caches and in the main memory are invalidated or updated in accordance with the modification.

As is known, an Input/Output (I/O) device is adapted to interface between a network or a peripheral device, such as a printer, storage device, etc., and a central processing unit (CPU). The I/O device may, for example, receive data from the peripheral device and supply that data to the CPU for processing. The controlled hand-off of data between the CPU and the I/O device is usually based on a model, such as the well known producer/consumer model. In accordance with this model, the I/O device writes the data into a main memory and subsequently sends a signal to inform the CPU of the availability of the data. The signal to the CPU may be issued in a number of different ways. For example, a write operation carried out at a separate memory location may be used as such as a signal. Alternatively, a register disposed in the IO device may be set, or an interrupt may be issued to the CPU to signal the availability of the data.

In systems implementing the non-posted write protocol, no signal is sent to the CPU until the I/O device is notified that all the I/O write data is visible to the CPU. In systems implementing the posted write protocol, the IO device has no knowledge of when the I/O write data are made visible to the CPU. Systems supporting the posted-write protocol are required to adhere to a number of rules, as set forth in the specification for Peripheral Component Interconnect (PCI). One of these rules requires that posted I/O write data become visible to CPUs in the same order that they are written by the I/O device. Another one of these rules requires that when the CPU attempts to read a register disposed in an IO device, the response not be delivered to the CPU until after all previous I/O write data are made visible to the CPU. Read and write requests from a CPU to an IO device are commonly referred to as Memory-Mapped IO (MMIO) read and write requests, respectively.

In systems that support I/O coherency, write operations may take different paths to the memory. For example, one write operation may be to a coherent address space that requires updates to the CPUs' caches, while another write operation may be to a non-coherent address space that can proceed directly to the main memory, rendering compliance with the above rules difficult. Similarly, in such systems, responses to I/O read requests may not follow the same path as the write operations to the memory. Accordingly, in such systems, satisfying the second rule also poses a challenging task.

### BRIEF SUMMARY OF THE INVENTION

A method of processing write requests in a computer system, in accordance with one embodiment of the present invention, includes in part, issuing a non-coherent I/O write request, stalling the non-coherent I/O write request until all pending coherent I/O write requests issued prior to issuing the non-coherent I/O write request are made visible to all processing cores, and delivering the non-coherent I/O write request to a memory after all the pending coherent I/O write requests issued prior to issuing the non-coherent I/O write request are made visible to all processing cores.

A central processing unit, in accordance with another embodiment of the present invention, includes, in part, a multitude of processing cores and a coherence manager adapted to maintain coherence between the multitude of processing cores. The coherence manager is configured to receive non-coherent I/O write requests, stall the non-coherent I/O write requests until all pending coherent I/O write requests issued prior to issuing the non-coherent I/O write requests are made visible to all of the processing cores, and deliver the non-coherent I/O write requests to an external memory after all the pending coherent I/O write requests issued prior to issuing the non-coherent write request are made visible to all processing cores.

In one embodiment, the coherence manager further includes a request unit, an intervention unit, a memory interface unit and a response unit. The request unit is configured to receive a coherent request from one of the cores and to selectively issue a speculative request in response. The intervention unit is configured to send an intervention message associated with the coherent request to the cores. The memory interface unit is configured to receive the speculative request and to selectively forward the speculative request to a memory. The response unit is configured to supply data associated with the coherent request to the requesting core.

A method of handling Input/Output requests, in accordance with one embodiment of the present invention includes, in part, incrementing a first count in response to receiving an I/O write request, incrementing a second count if the I/O write request is detected as being a coherent I/O write request, incrementing a third count if I/O the write request is detected as being a non-coherent I/O write request, setting a fourth count to a first value defined by the first count in response to receiving an MMIO read response, setting a fifth count to a second value defined by the second count in response to receiving the MMIO read response, setting a sixth count to a third value defined by the third count in response to receiving the MMIO read response, decrementing the first count in response to incrementing the second count or the third count, decrementing the second count when the detected coherent I/O write request is made visible to all processing cores, decrementing the third count when the detected non-coherent I/O write request is made visible to all processing cores, decrementing the fourth count in response to decrementing the first count as long as the fourth count is greater than a predefined value (e.g., 0), decrementing the fifth count in response to decrementing the second count as long as the fifth count is greater than the predefined value, incrementing the fifth count if the second count is incremented and while the fourth count is not equal to a first predefined value, decrementing the sixth count in response to decrementing the third count as long as the sixth count is greater than the predefined value, incrementing the sixth count if the third count is incremented and while the fourth count is not equal to the first predefined value, and transferring the MMIO read response to a processing unit that initiated the MMIO read request when a sum of the fourth, fifth and sixth counts reaches a second predefined value.

In one embodiment, the first value is equal to the first count, the second value is equal to the second count, and the third value is equal to said third count. In one embodiment, the first and second predefined values are zero. In one embodiment, the method of handling Input/Output requests further includes storing the MMIO read response in a first buffer, and storing the MMIO read response in a second buffer. In one embodiment, the fourth, fifth and sixth counters are decremented to a third predefined value before being respectively set to the first, second and third values if a second MMIO read response is present in the second buffer when the first MMIO read response is stored in the second buffer. The third predefined value may be zero. In one embodiment, if a sum of the fourth, fifth and sixth counts is equal to a third predefined value when the MMIO read response is stored in the first buffer, the MMIO read response is transferred to a processing unit that initiated the MMIO read request. In one embodiment, the third predefined value is zero.

A central processing unit, in accordance with one embodiment of the present invention, includes in part, first, second, third, fourth, fifth, and sixth counters as well as a coherence block. The first counter is configured to increment in response to receiving a I/O write request and to decrement in response to incrementing the second or third counters. The second counter is configured to increment if the I/O write request is detected as being a coherent I/O write request and to decrement when the detected coherent I/O write request is made visible to all processing cores. The third counter is configured to increment if the I/O write request is detected as being a non-coherent I/O write request and to decrement when the detected non-coherent I/O write request is made visible to all processing cores. The fourth counter is configured to be set to a first value defined by the first counter's count in response to receiving an MMIO read response. The fourth counter is configured to decrement in response to decrementing the first counter as long as the fourth counter's count is greater than e.g., zero. The fifth counter is configured to be set to a second value defined by the second counter's count in response to receiving the MMIO read response. The fifth counter is configured to decrement in response to decrementing the second counter as long as the fifth counter's count is greater than, e.g., zero. The fifth counter is further configured to increment in response to incrementing the second counter if the fourth counter's count is not equal to a first predefined value. The sixth counter is configured to be set to a third value defined by the second counter's count in response to receiving an MMIO read response. The sixth counter is configured to decrement in response to decrementing the third counter as long as the sixth counter's count is greater than, e.g., zero. The sixth counter is further configured to increment in response to incrementing the third counter if the fourth counter's count is not equal to the first predefined value. The coherence block is configured to transfer the MMIO read response to a processing unit that initiated the MMIO read request when a sum of the fourth, fifth and sixth counts reaches a second predefined value.

In one embodiment, the first value is equal to the first counter's count, the second value is equal to the second counter's count, and the third value is equal to the third counter's count. In one embodiment, the first and second predefined values are zero. In one embodiment, the central processing unit further includes, in part, a first buffer adapted to store the response to the I/O read request, and a second buffer adapted to receive and store the response to the I/O read request from the first buffer.

In one embodiment, the fourth, fifth and sixth counters are decremented to a third predefined value before being respectively set to the first, second and third counters' counts if an MMIO read response is present in the second buffer at the time the first MMIO read response stored in the second buffer. In one embodiment, the third predefined value is zero. In one embodiment, the central processing unit further includes a first buffer adapted to store the MMIO read response, and a block configured to transfer the MMIO read response the first buffer to a processing unit that initiated the MMIO read request if a sum of the counts of the fourth, fifth and sixth counters is equal to a third predefined value when the MMIO read response is stored in the first buffer.

A central processing unit, in accordance with one embodiment of the present invention, includes in part, a multitude of processing cores, an Input/Output (I/O) coherence unit adapted to control coherent traffic between at least one I/O device and the multitude of processing cores, and a coherence manager adapted to maintain coherence between the plurality of processing cores. The coherence manager includes, in part, a request unit configured to receive a coherent request from one of the multitude of cores and to selectively issue a speculative request in response, an intervention unit configured to send an intervention message associated with the coherent request to the multitude of cores, a memory interface unit configured to receive the speculative request and to selectively forward the speculative request to a memory, a response unit configured to supply data associated with the coherent request to the requesting cores, a request mapper adapted to determine whether a received request is a memory-mapped I/O request or a memory request, a serializer adapted to serialize received requests, and a serialization arbiter adapted so as not to select a memory mapped input/output request for serialization by the serializer if a memory input/output request serialized earlier by the serializer has not been delivered to the I/O coherence unit.

A method of handling Input/Output requests in a central processing unit includes, in part, a multitude of processing cores, an Input/Output coherence unit adapted to control coherent traffic between at least one I/O device and the multitude of processing cores, and a coherence manager adapted to maintain coherence between the multitude of processing cores. The method includes identifying whether a first request is a memory-mapped Input/Output request, serializing the first request, attempting to deliver the first request to the Input/Output coherence unit if the first request is identified as a memory-mapped Input/Output request, identifying whether a second request is a memory-mapped Input/Output request, and disabling serialization of the second request if the second request is identified as being a memory-mapped I/O request and until the first request is received by the Input/Output coherence.

### BRIEF DESCRIPTION OF THE DRAWINGS

FIG. 1 shows a multi-core microprocessor, in communication with a number of I/O devices and a system memory, in accordance with one embodiment of the present invention.

FIG. 2 is a block diagram of the cache coherence manger disposed in the microprocessor of FIG. 1, in accordance with one exemplary embodiment of the present invention.

FIG. 3 is an exemplary block diagram of the cache coherence manager and I/O coherence manager of the multi-core microprocessor of FIG. 1.

FIGS. 4 is a flowchart of steps showing the manner in which coherent and non-coherent write requests are handled with respect to one another, in accordance with one exemplary embodiment of the present invention.

FIG. 5 is a block diagram of an I/O coherence manager of the multi-core microprocessor of FIG. 1, in accordance with one exemplary embodiment of the present invention.

FIG. 6 is a flowchart of steps carried out to handle an I/O write request and an MMIO read response, in accordance with one exemplary embodiment of the present invention.

FIG. 7 is another exemplary block diagram of the cache coherence manager and I/O coherence manager of the multi-core microprocessor of FIG. 1.

FIG. 8 shows the separate data paths associated with MMIO data and memory data, in accordance with one embodiment of the present invention.

FIG. 9 shows an exemplary computer system in which the present invention may be embodied.

### DETAILED DESCRIPTION OF THE INVENTION

In accordance with one embodiment of the present invention, a multi-core microprocessor includes, in part, a cache coherence manager that maintains coherence among the multitude of microprocessor cores, and an I/O coherence unit that maintains coherent traffic between the I/O devices and the multitude of processing cores of the microprocessor. In accordance with one aspect of the present invention, the I/O coherence unit stalls non-coherent I/O write requests until it receives acknowledgement that all pending coherent I/O write requests issued prior to the non-coherent I/O write requests have been made visible to the processing cores. In accordance with another aspect of the present invention, the I/O coherence unit ensures that MMIO read responses are not delivered to the processing cores until after all previous I/O write requests are made visible to the processing cores. In accordance with yet another aspect of the present invention, in order to prevent deadlock conditions that may occur as a result of enforcing the requirement that MMIO read responses be ordered behind I/O write requests, the determination as to whether a request is a memory request or an MMIO request is made prior to serializing that request.

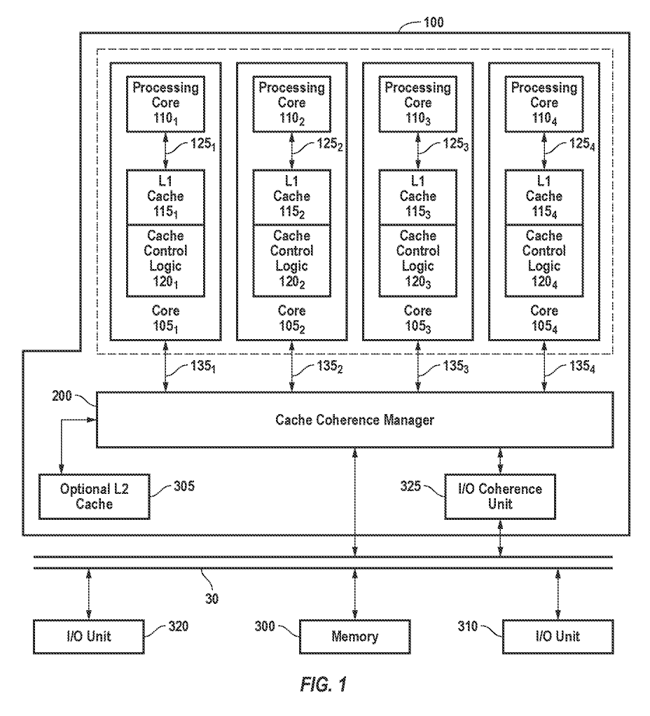

FIG. 1 is a block diagram of a microprocessor 100, in accordance with one exemplary embodiment of the present invention, that is in communication with system memory 300 and I/O units 310, 320 via system bus 30. Microprocessor (hereinafter alternatively referred to as processor) 100 is shown as including, in part, four cores 105₁, 105₂, 105₃ and 105₄, a cache coherency manger 200, and an optional level-2 (L2) cache 305. Each core 105ᵢ, where i is an integer ranging from 1 to 4, is shown as including, in part, a processing core 110ᵢ, an L1 cache 115ᵢ, and a cache control logic 120ᵢ. Although exemplary embodiment of processor 100 is shown as including four cores, it is understood that other embodiments of processor 100 may include more or fewer than four cores.

Each processing core 110ᵢ is adapted to perform a multitude of fixed or flexible sequence of operations in response to program instructions. Each processing core 110ᵢ may conform to either CISC and/or RISC architectures to process scalar or vector data types using SISD or SIMD instructions. Each processing core 110ᵢ may include general purpose and specialized register files and execution units configured to perform logic, arithmetic, and any other type of data processing functions. The processing cores 110₁, 110₂, 110₃ and 110₄, which are collectively referred to as processing cores 110, may be configured to perform identical functions, or may alternatively be configured to perform different functions adapted to different applications. Processing cores 110 may be single-threaded or multi-threaded, i.e., capable of executing multiple sequences of program instructions in parallel.

Each core 105ᵢ is shown as including a level-1 (L1) cache. In other embodiments, each core 110ᵢ may include more levels of cache, e.g., level 2, level 3, etc. Each cache 115ᵢ may include instructions and/or data. Each cache 115ᵢ is typically organized to include a multitude of cache lines, with each line adapted to store a copy of the data corresponding with one or more virtual or physical memory addresses. Each cache line also stores additional information used to manage that cache line. Such additional information includes, for example, tag information used to identify the main memory address associated with the cache line, and cache coherency information used to synchronize the data in the cache line with other caches and or with the main system memory. The cache tag may be formed from all or a portion of the memory address associated with the cache line.

Each L1 cache 115ᵢ is coupled to its associated processing core 110ᵢ via a bus 125ᵢ. Each bus 125ᵢ includes a multitude of signal lines for carrying data and/or instructions. Each core 105ᵢ is also shown as including a cache control logic 120ᵢ to facilitate data transfer to and from its associated cache 115ᵢ. Each cache 115ᵢ may be fully associative, set associative with two or more ways, or direct mapped. For clarity, each cache 115ᵢ is shown as a single cache memory for storing data and instructions required by core 105ᵢ. Although not shown, it is understood that each core 105ᵢ may include an L1 cache for storing data, and an L1 cache for storing instructions.

Each cache 115ᵢ is partitioned into a number of cache lines, with each cache line corresponding to a range of adjacent locations in shared system memory 300. In one embodiment, each line of each cache, for example cache 115₁, includes data to facilitate coherency between, e.g., cache 115₁, main memory 300 and any other caches 115₂, 115₃, 115₄, intended to remain coherent with cache 115₁, as described further below. For example, in accordance with the MESI cache coherency protocol, each cache line is marked as being modified “M”, exclusive “E”, Shared “S”, or Invalid “I”, as is well known. Other cache coherency protocols, such as MSI, MOSI, and MOESI coherency protocols, are also supported by the embodiments of the present invention.

Each core 105ᵢ is coupled to a cache coherence manager 200 via an associated bus 135ᵢ. Cache coherence manager 200 facilitates transfer of instructions and/or data between cores 105ᵢ, system memory 300, I/O units 310, 320 and optional shared L2 cache 305. Cache coherency manager 200 establishes the global ordering of requests, sends intervention requests, collects the responses to such requests, and sends the requested data back to the requesting core. Cache coherence manager 200 orders the requests so as to optimize memory accesses, load balance the requests, give priority to one or more cores over the other cores, and/or give priority to one or more types of requests over the others.

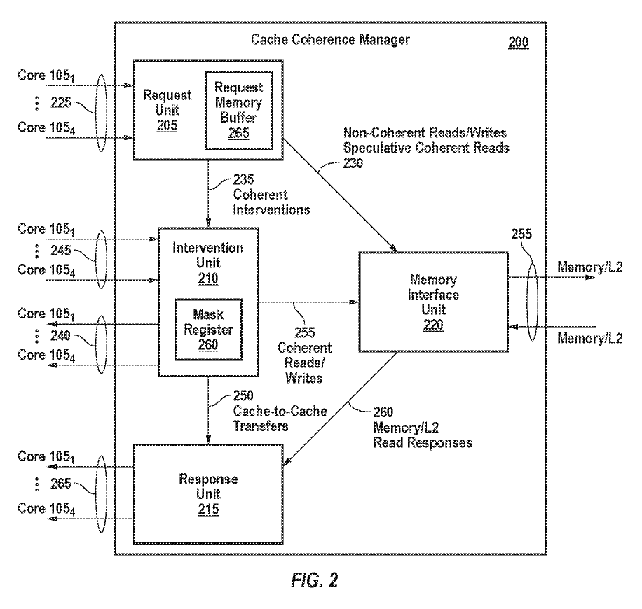

FIG. 2 is a block diagram of cache coherence manager (alternatively referred to hereinbelow as coherence manager, or CM) 200, in accordance with one embodiment of the present invention. Cache coherence manager 200 is shown as including, in part, a request unit 205, an intervention unit 210, a response unit 215, and a memory interface unit 220. Request unit 205 includes input ports 225 adapted to receive, for example, read requests, write requests, write-back requests and any other cache memory related requests from cores 105ᵢ. Request unit 205 serializes the requests it receives from cores 105ᵢ and sends non-coherent read/write requests, speculative coherent read requests, as well as explicit and implicit writeback requests of modified cache data to memory interface unit 220 via port 230. Request unit 205 sends coherent requests to intervention unit 210 via port 235. In order to avoid a read after write hazard, the read address is compared against pending coherent requests that can generate write operations. If a match is detected as a result of this comparison, the read request is not started speculatively.

In response to a coherent intervention request received from request unit 205, intervention unit 210 issues an intervention message via output ports 240. A hit will cause the data to return to the intervention unit via input ports 245. Intervention unit 250 subsequently forwards this data to response unit 215 via output ports 250. Response unit 215 forwards this data to the requesting (originating the request) core via output ports 265. If there is a cache miss and the read request is not performed speculatively, intervention unit 210 requests access to this data by sending a coherent read or write request to memory interface unit 220 via output ports 255. A read request may proceed without speculation when, for example, a request memory buffer disposed in request unit 205 and adapted to store and transfer the requests to memory interface unit 220 is full.

Memory interface unit 220 receives non-coherent read/write requests from request unit 205, as well as coherent read/write requests and writeback requests from intervention unit 210. In response, memory interface unit 220 accesses system memory 300 and/or higher level cache memories such as L2 cache 305 via input/output ports 255 to complete these requests. The data retrieved from memory 300 and/or higher level cache memories in response to such memory requests is forwarded to response unit 215 via output port 260. The response unit 215 returns the data requested by the requesting core via output ports 265. As is understood, the requested data may have been retrieved from an L1 cache of another core, from system memory 300, or from optional higher level cache memories.

Referring to FIG. 1, coherent traffic between the I/O devices (units) 310, 320 and the processing cores 110ᵢ is handled by I/O coherence unit 325 and through coherence manager 200. This allows the I/O devices to access memory 300 while keeping coherent with the caches 110ᵢ disposed in the processing cores. Coherent IO read and write requests are received by I/O coherence unit 325 and delivered to coherence manager 200. In response, coherence manager 200 generates intervention requests to the processing cores 110ᵢ to query the L1 caches 115ᵢ. Consequently, I/O read requests retrieve the latest values from memory 300 or caches 115ᵢ. I/O write requests will invalidate stale data stored in L1 caches 115ᵢ and merge the newer write data with any existing data as needed.

I/O write requests are received by I/O coherence unit 325 and transferred to coherence manager 200 in the order they are received. Coherence manager 200 provides acknowledgement to I/O coherence unit (hereinafter alternatively referred to as IOCU) 325 when the write data is made visible to processing cores 110ᵢ. Non-coherent I/O write requests are made visible to all processing cores after they are serialized. Coherent I/O write requests are made visible to all processing cores after the responses to their respective intervention messages are received. IOCU 325 is adapted to maintain the order of I/O write requests. Accordingly, if coherent I/O write requests are followed by non-coherent I/O write requests, IOCU 325 does not issue the non-coherent I/O write requests until after all previous coherent I/O write requests are made visible to all processing cores by coherence manager 200, as described in detail below.

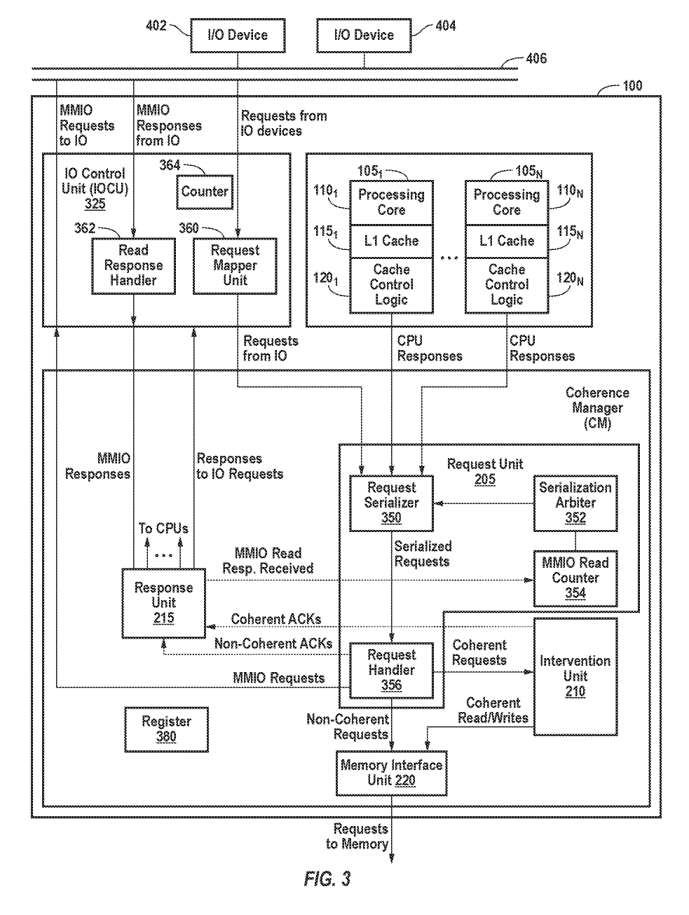

FIG. 3 shows a number of blocks disposed in IOCU 325 and CM 200, in accordance with one exemplary embodiment of the present invention. Request unit 205 of CM 200 is shown as including a request serializer 350, a serialization arbiter 352, a MMIO read counter 354 and a request handler 356. To avoid deadlocks, an I/O device is not allowed to make a read/write request to another I/O device through coherence manager 200. Instead, if an I/O device, e.g., I/O device 402, issues a request to read data from another I/O device, e.g. I/O device 406, both the request and the response to the request are carried out via an I/O bus 406 with which the two I/O devices are in communication. If an I/O device attempts to make a read/write requests to another I/O device through coherence manager 200, a flag is set to indicate an error condition. IOCU 325 is the interface between the I/O devices and CM 200. IOCU 325 delivers memory requests it receives from the I/O devices to CM 200, and when required, delivers the corresponding responses from CM 200 to the requesting I/O devices. IOCU 325 also delivers MMIO read/write requests it receives from CM 200 to the I/O devices, and when required, delivers the corresponding responses from the IO devices to the requesting core via CM 200.

Requests from I/O devices (hereinafter alternatively referred to as I/Os) are delivered to request serializer 350 via request mapper unit 360. Requests from the CPU cores 105 are also received by request serializer 350. Request serializer 350 serializes the received requests and delivers them to request handler 356. MMIO requests originated by the processing cores are transferred to IOCU 325 and subsequently delivered to the I/O device that is the target of the request.

The path from the request mapper unit 360 to the request serializer 350 is a first-in-first-out path. Accordingly, I/O requests, such as I/O write requests maintain their order as they pass through IOCU 325. However, depending on whether the I/O requests are coherent or non-coherent, they may take different paths through the CM 200. Non-coherent I/O write requests are transferred to the memory via memory interface 220 and are made visible to the processing cores after being received by request handler 356. Coherent I/O write requests, on the other hand, are transferred to intervention unit 210, which in response sends corresponding intervention messages to the processing cores to query their respective L1 and/or L2 caches. If there is a cache hit, the corresponding cache line(s) is invalidated at which time the I/O write data is made visible to cores 105ᵢ. Accordingly, a coherent I/O write request often experiences an inherently longer path delay than a non-coherent I/O write request.

Assume an I/O device issues a coherent I/O write request that is followed by a non-coherent I/O write request. As described above, because of the differential path delays seen by the I/O coherent and non-coherent write requests, in the absence of present invention described herein, the non-coherent I/O write request may become visible to the CPU cores before the coherent I/O write requests; this violates the rule that requires the write data be made visible to the CPUs in the same order that their respective write requests are issued by the I/O devices.

To ensure that I/O write data are made visible to the processing cores in the same order that their respective I/O write requests are issued, IOCU 325 keeps track of the number of outstanding (pending) coherent I/O write requests. As is discussed below, IOCU 325 includes a request mapper 360 that determines the coherency attribute of I/O write requests. Using the coherency attribute, IOCU 325 stalls non-coherent I/O write requests until it receives acknowledgement from CM 200 that all pending coherent I/O write requests have been made visible 406 to the processing cores.

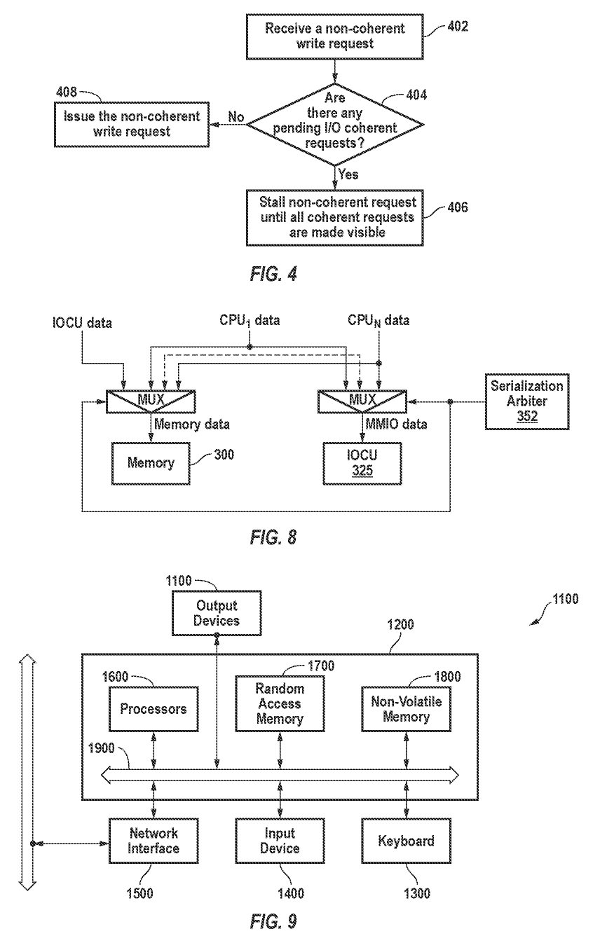

FIG. 4 is a flowchart 400 depicting the manner in which coherent and non-coherent I/O write requests are handled. Upon receiving a non-coherent I/O write request 402, an I/O coherence unit performs a check to determine whether there are any pending I/O coherent write requests. If the I/O coherence unit determines that there are pending I/O coherent write requests 404, the I/O coherence unit stalls (does not issue) the non-coherent I/O write request until each of the pending coherent I/O write requests are made visible to all processing cores. In other words, the I/O coherence unit stalls all non-coherent I/O write requests until it receives acknowledgement that all pending coherent I/O write requests have been made visible to the processing cores.

Referring to FIG. 3, to ensure that I/O write data are made visible to the processing cores in the same order that their respective I/O write requests are issued, in one embodiment, IOCU 325 includes a counter 364. Counter 364's count is incremented each time IOCU 325 transmits a coherent I/O write request to coherence manager 200 and decremented each time coherence manager 200 notifies IOCU 325 that a coherent I/O write request has been made visible to the processing cores. IOCU 325 does not send a non-coherent I/O write request to CM 200 unless counter 364's count has a predefined (e.g., zero) value. After, IOCU 325 determines that there are no pending I/O coherent write requests 404, IOCU 325 issues the non-coherent I/O write request 408.

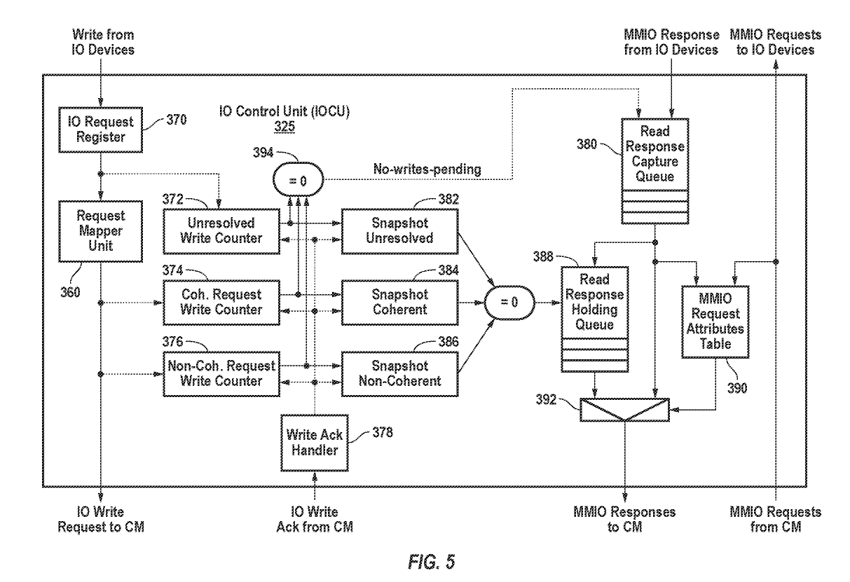

FIG. 5 is a block diagram of IOCU 325, in accordance with one exemplary embodiment of the present invention. Referring concurrently to FIGS. 3 and 5, MMIO read requests are delivered to target I/O devices via CM 200 and IOCU 325. Likewise, responses to the MMIO read requests received from the target I/O devices are returned to the requesting cores via IOCU 325 and CM 200. As is seen from FIGS. 3 and 5, the MMIO read responses are returned along a path that is different from the paths along which the I/O write requests are carried out. In accordance with one aspect of the present invention, IOCU 325 includes logic blocks adapted to ensure that MMIO read responses from an I/O device are not delivered to the processing cores until after all previous I/O write requests are made visible to the processing cores. To achieve this, IOCU 325 keeps track of the number of outstanding I/O write requests. Accordingly, when receiving a MIMO read response, IOCU 325 maintains a count of the number of I/O write requests that are ahead of that MMIO read response and that must be completed before that MMIO read response is returned to its requester.

IOCU 325 is shown as including, in part, a read response capture buffer (queue) 380, a read response holding queue 388, a multitude of write counters, namely an unresolved write counter 372, a coherent request write counter 374, and a non-coherent request write counter 376, collectively and alternatively referred to herein as write counters, as well as a multitude of snapshot counters, namely an unresolved snapshot counter 382, a coherent request snapshot counter 384, and a non-coherent snapshot counter 386, collectively and alternatively referred to herein as snapshot counters.

Upon receiving an I/O write request via I/O request register 370, unresolved write counter 372 is incremented. Request mapper unit I/O 360 also receives the I/O write request from I/O request register 370 and determines the coherence attribute of the I/O write request. If the I/O write request is determined as being a coherent I/O write request, unresolved write counter 372 is decremented and coherent request write counter 374 is incremented. If, on the other hand, the I/O write request is determined as being a non-coherent I/O write request, unresolved write counter 372 is decremented and non-coherent request write counter 374 is incremented. Coherent request counter 374 is decremented when CM 200 acknowledges that an associated coherent I/O write request is made visible to the requesting core. Likewise, non-coherent request counter 376 is decremented when CM 200 acknowledges that an associated non-coherent I/O write request is made visible to the requesting core.

The sum of the counts in the write counters at a time when a MIMO read response is received represents the number of pending I/O write requests that must be made visible to all processing cores before that MIMO read response is returned to the requesting core. This sum is replicated in the snapshot counters at the time the MIMO read response is received by (i) copying the content, i.e., count, of unresolved write counter 372 to unresolved snapshot counter 382, (ii) copying the count of coherent request write counter 374 to coherent request snapshot counter 384, and (iii) copying the count of non-coherent request write counter 376 to non-coherent snapshot counter 386.

The snapshot counters are decremented whenever the write counters are decremented until the counts of the snapshot counters reach a predefined value (e.g., zero). So long as unresolved snapshot counter 382's count is greater than the predefined value, unresolved snapshot counter 382 is decremented when unresolved write counter 372 is decremented. So long as coherent request snapshot counter 384's count is greater that the predefined value, coherent request snapshot counter 384 is decremented when coherent request write counter 372 is decremented. Likewise, so long as non-coherent request snapshot counter 386's count is greater that the predefined value, non-coherent request snapshot counter 386 is decremented when non-coherent request write counter 382 is decremented. Furthermore, snapshot counters 384 and 386 are incremented when snapshot counter 382 is non-zero, i.e., the snapshot counters are waiting for some I/O write requests to become resolved, and an unresolved I/O write request becomes resolved, i.e., when either counter 374 or 376 is incremented. When the counts of the snapshot counters reach predefined values (e.g., zero), the MMIO read response stored in the MMIO read response holding queue 388 is delivered to the requesting core.

A response to an MMIO read request is first received and stored in read response capture queue 380. Such a response is subsequently retrieved from read response capture queue (RRCQ) 380 and loaded in read response holding queue (RRHQ) 388. If RRHQ 388 is empty when it receives the new read response, then unresolved snapshot counter 382's count is set equal to write counter 372's count; coherent request snapshot counter 384's count is set equal to coherent request write counter 374's count; and non-coherent snapshot counter 386's count is set equal to non-coherent request write counter 376's count. So long as their respective counts remain greater than the predefined value, the snapshot counters are decremented at the same time their associated write counters are decremented. Furthermore, snapshot counters 384 and 386 are incremented when snapshot counter 382 is non-zero, i.e., the snapshot counters are waiting for some I/O write requests to become resolved, and an unresolved I/O write request becomes resolved, i.e., when either counter 374 or 376 is incremented. The response to the MMIO read request remains in RRHQ 388 until all 3 snapshot counters are decremented to predefined values (e.g., zero). At that point, all previous I/O write requests are complete and the response to the MMIO read request is dequeued from RRHQ 388 and delivered to the CM 200.

If RRHQ 388 includes one or more MMIO read responses at a time it receives a new MMIO read response, because at that time the snapshot counters 382, 384 and 386 are being used to count down the number of pending I/O write requests that are ahead of such earlier MMIO read responses, the snapshot counters are not loaded with the counts of the write counters. When the snapshot counters reach predefined counts (e.g., 0), the earlier MMIO read response is dequeued and delivered to its respective requesters. The new MMIO read response then moves to the top of the queue and the snapshot counters are loaded with the values of their corresponding write counters. The response that is now at the top of the RRHQ 338 is not delivered to the requesting core until after the counts of the snapshot registers 382, 384, and 386 reach predefined value of, e.g., zero.

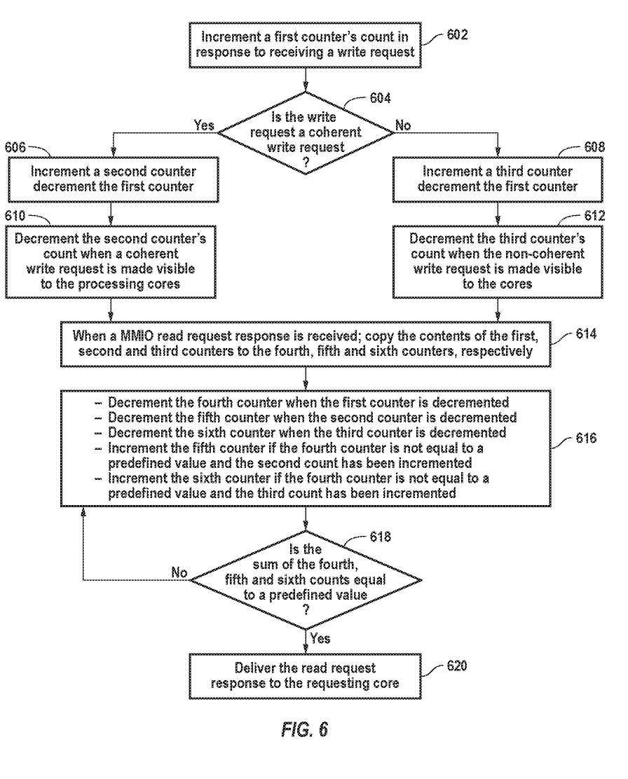

FIG. 6 is a flowchart 600 of steps carried out to handle I/O write request and response to MMIO read requests, in accordance with one embodiment of the present invention. Upon receiving an I/O write request, a first counter's count is incremented 602. Thereafter, the coherence attribute of the I/O write request is determined 604. If the I/O write request is determined as being a coherent I/O write request, a second counter's count is incremented and the first counter's count is decremented 606. If, on the other hand, the I/O write request is determined as being a non-coherent I/O write request, a third counter's count is incremented and the first counter's count is decremented 608. The second counter's count is decremented 610 when the coherent I/O write request is made visible to all the processing cores. Likewise, the third counter's count is decremented 612 when the coherent I/O write request is made visible to all the processing cores.

When a MIMO read response is received, a fourth counter receives the count of the first counter, a fifth counter receives the count of the second counter, and a sixth counter receives the count of the third counter 614. So long as its count remains greater than a predefined value (e.g. zero), the fourth counter is decremented whenever the first counter is decremented. So long as its count remains greater than the predefined value, the fifth counter is decremented whenever the second counter is decremented. So long as its count remains greater than a predefined value the sixth counter is decremented whenever the third counter is decremented 616. The fifth counter's count is incremented if the second counter's count is incremented while the fourth counter's count is not zero. Likewise, the sixth counter's count is incremented if the third counter's count is incremented while the fourth counter's count is not zero. When the sum of the counts of the fourth, fifth and sixth counters reaches a predefined value (such as zero) 618, the MMIO read response is delivered to the requesting core 620.

In some embodiments, only responses to MMIO read requests that target I/O device registers are stored in the buffers in order to satisfy the ordering rules. MMIO read requests to memory type devices (e.g., ROMs) are not subject to the same ordering restrictions and thus do not have to satisfy the ordering rules. Referring to FIG. 5, attributes associated with the original transaction may be used to determine whether an MMIO read response is of the type that is to be stored in RRCQ 380. These attributes are stored in the MMIO request attributes table 390 when the MMIO read request is first received by IOCU 325. The attributes are subsequently retrieved when the corresponding response is received. If the attributes indicate that no buffering (holding) is required, the response is immediately sent to the CM 200.

In some embodiments, when an MMIO read response is loaded into the read response capture queue 380, a “no-writes-pending” bit is set if at that time unresolved write counter 372, coherent request write counter 374, and non-coherent request write counter 376 have predefined counts (e.g., zero). When the “no-writes-pending” bit is set and the RRHQ 388 is empty, then the MMIO read response is sent to CM 200 via signal line A using multiplexer 392.

In accordance with another embodiment of the present invention, in order to prevent deadlock conditions that may occur as a result of enforcing the requirement that MMIO read responses be ordered behind I/O write requests, the determination as to whether a request is a memory request or an MMIO request is made prior to serializing that request.

Assume that a core has issued a number of MMIO read requests to an I/O device causing the related IOCU 325 buffers to be full. Assume that a number of I/O write requests are also pending. Assume further that one of the cores issues a new MMIO read request. Because the IOCU 325 read request queues are assumed to be full, IOCU 325 cannot accept any new MMIO read requests. Since the pending MMIO read requests are assumed as being behind the I/O write requests, the responses to the MMIO read requests cannot be processed further until all previous I/O write requests are completed to satisfy the ordering rules. The I/O write requests may not, however, be able to make forward progress due to the pending MMIO read requests. The new MMIO request therefore may cause the request serializer 325 to stall, thereby causing a deadlock.

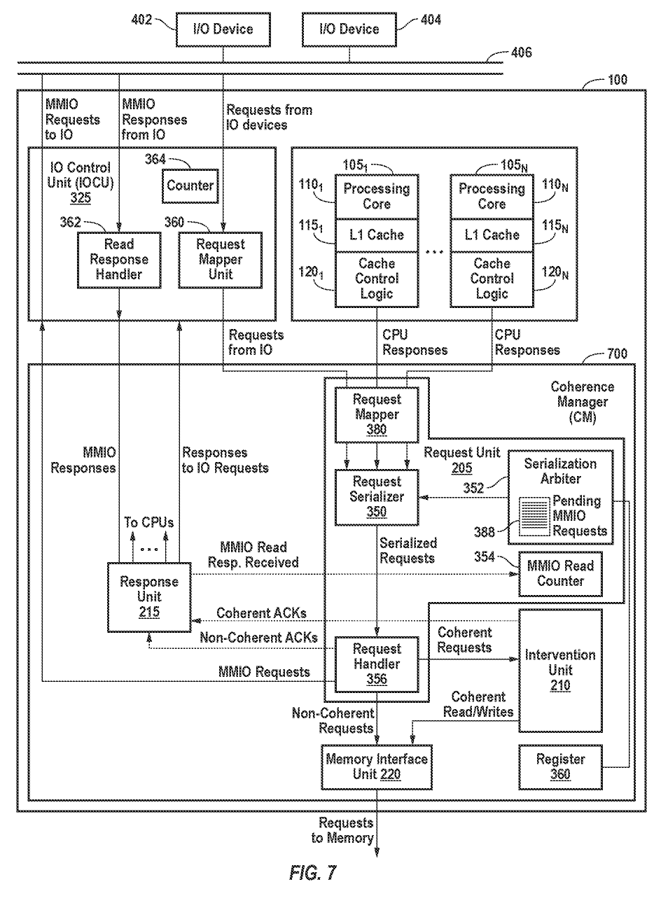

FIG. 7 shows, in part, another exemplary embodiment 700 of a coherence manager of a multi-core processor of the present invention. Embodiment 700 is similar to embodiment 200 except that in embodiment 700, coherence manager 200 includes a request mapper 380 configured to determine and supply request serializer 350 with information identifying whether a request is a memory request or an MMIO request. In accordance with exemplary embodiment 700, request serializer 350 does not serialize a new MMIO request if one or more MMIO requests are still present in coherence manager 700 and have not yet been delivered to IOCU 325. Pending MMIO request are shown as being queued in buffer 388. In one embodiment, up to one MMIO per processing core may be stored in buffer 388. Furthermore, if the first MMIO request is an MMIO write request, then the serialization arbiter 352 will not serialize a subsequent request until all the data associated with the MMIO write request is received by IOCU 325. To further ensure that such deadlock does not occur, the memory requests and MMIO requests have different datapaths within request unit 205.

FIG. 8 shows the flow of data associated with both MMIO and memory data in request unit 205 for a central processing unit having N cores. As is seen from FIG. 8, the memory data is shown as flowing to the memory 300, whereas the MMIO data flows to the IOCU 325 via the IOCU MMIO data port. In other words, the two data paths are distinct from one another.

Register 360 disposed in coherence manager 200 is used to determine whether IOCU 325 can accept new MMIO requests. Serialization arbiter 352 is adapted so as not to select an MMIO request from a processing core so long as register 360 is set indicating that a serialized MMIO request is still present in coherence manager 700 and has not yet been delivered to IOCU 325. When the serialized MMIO request is delivered to IOCU 325, register 360 is reset to indicate that a new MMIO request may be serialized.

FIG. 8 illustrates an exemplary computer system 1000 in which the present invention may be embodied. Computer system 1000 typically includes one or more output devices 1100, including display devices such as a CRT, LCD, OLED, LED, gas plasma, electronic ink, or other types of displays, speakers and other audio output devices; and haptic output devices such as vibrating actuators; computer 1200; a keyboard 1300; input devices 1400; and a network interface 1500. Input devices 1400 may include a computer mouse, a trackball, joystick, track pad, graphics tablet, touch screen, microphone, various sensors, and/or other wired or wireless input devices that allow a user or the environment to interact with computer system 1000. Network interface 1500 typically provides wired or wireless communication with an electronic communications network, such as a local area network, a wide area network, for example the Internet, and/or virtual networks, for example a virtual private network (VPN). Network interface 1500 can implement one or more wired or wireless networking technologies, including Ethernet, one or more of the 802.11 standards, Bluetooth, and ultra-wideband networking technologies.

Computer 1200 typically includes components such as one or more general purpose processors 1600, and memory storage devices, such as a random access memory (RAM) 1700 and non-volatile memory 1800. Non-volatile memory 1800 can include floppy disks; fixed or removable hard disks; optical storage media such as DVD-ROM, CD-ROM, and bar codes; non-volatile semiconductor memory devices such as flash memories; read-only-memories (ROMS); battery-backed volatile memories; paper or other printing mediums; and networked storage devices. System bus 1900 interconnects the above components. Processors 1600 may be a multi-processor system such as multi-processor 100 described above.

RAM 1700 and non-volatile memory 1800 are examples of tangible media for storage of data, audio/video files, computer programs, applet interpreters or compilers, virtual machines, and embodiments of the present invention described above. For example, the above described embodiments of the processors of the present invention may be represented as computer-usable programs and data files that enable the design, description, modeling, simulation, testing, integration, and/or fabrication of integrated circuits and/or computer systems. Such programs and data files may be used to implement embodiments of the invention as separate integrated circuits or used to integrate embodiments of the invention with other components to form combined integrated circuits, such as microprocessors, microcontrollers, system on a chip (SoC), digital signal processors, embedded processors, or application specific integrated circuits (ASICs).

Programs and data files expressing embodiments of the present invention may use general-purpose programming or scripting languages, such as C or C++; hardware description languages, such as VHDL or Verilog; microcode implemented in RAM, ROM, or hard-wired and adapted to control and coordinate the operation of components within a processor or other integrated circuit; and/or standard or proprietary format data files suitable for use with electronic design automation software applications known in the art. Such program and data files when stored in a tangible medium can cause embodiments of the present invention at various levels of abstraction. Programs and data files can express embodiments of the invention at various levels of abstraction, including as a functional description, as a synthesized netlist of logic gates and other circuit components, and as an integrated circuit layout or set of masks suitable for use with semiconductor fabrication processes. These programs and data files can be processed by electronic design automation software executed by a computer to design a processor and generate masks for its fabrication. Those of ordinary skill in the art will understand how to implement the embodiments of the present invention in such programs and data files.

Further embodiments of computer 1200 can include specialized input, output, and communications subsystems for configuring, operating, simulating, testing, and communicating with specialized hardware and software used in the design, testing, and fabrication of integrated circuits.

Although some exemplary embodiments of the present invention are made with reference to a processor having four cores, it is understood that the processor may have more or fewer than four cores. The arrangement and the number of the various devices shown in the block diagrams are for clarity and ease of understanding. It is understood that combinations of blocks, additions of new blocks, re-arrangement of blocks, and the like fall within alternative embodiments of the present invention. For example, any number of I/Os, coherent multi-core processors, system memories, L2 and L3 caches, and non-coherent cached or cacheless processing cores may also be used.

It is understood that the apparatus and methods described herein may be included in a semiconductor intellectual property core, such as a microprocessor core (e.g. expressed as a hardware description language description or a synthesized netlist) and transformed to hardware in the production of integrated circuits. Additionally, the embodiments of the present invention may be implemented using combinations of hardware and software, including micro-code suitable for execution within a processor.

The above embodiments of the present invention are illustrative and not limitative. Various alternatives and equivalents are possible. The invention is not limited by the type of integrated circuit in which the present disclosure may be disposed. Nor is the invention limited to any specific type of process technology, e.g., CMOS, Bipolar, BICMOS, or otherwise, that may be used to manufacture the various embodiments of the present invention. Other additions, subtractions or modifications are obvious in view of the present invention and are intended to fall within the scope of the appended claims.

What is claimed is:

1. A method of processing write requests in a computer system, the method comprising:
issuing a non-coherent I/O write request;
stalling the non-coherent I/O write request until prior issued pending coherent I/O write requests are made visible to a plurality of processing cores disposed in the computer system; and
delivering the non-coherent I/O write request to a memory after the prior issued pending coherent I/O write requests are made visible to the plurality of processing cores.

2. A central processing unit comprising a plurality of processing cores and a coherence manager adapted to maintain coherence between the plurality of processing cores, said central processing unit configured to:
receive a non-coherent I/O write request;
stall the non-coherent I/O write request until prior issued pending coherent I/O write requests are made visible to the plurality of processing cores; and
deliver the non-coherent I/O write request to an external memory after the prior issued pending coherent I/O write requests are made visible to the plurality of processing cores.

3. The central processing unit of claim 2 wherein said coherence manager further comprises:
a request unit configured to receive a coherent request from a first one of the plurality of cores and to selectively issue a speculative request in response;
an intervention unit configured to send an intervention message associated with the coherent request to the plurality of cores;
a memory interface unit configured to receive the speculative request and to selectively forward the speculative request to a memory; and
a response unit configured to supply data associated with the coherent request to the first one of the plurality of cores.

4. A method of handling Input/Output requests in a computer system, the method comprising:
incrementing a first count in response to receiving a write request from an I/O device;
incrementing a second count if the write request is detected as being a coherent write request;
incrementing a third count if the write request is detected as being a non-coherent write request;
setting a fourth count to a first value defined by the first count in response to receiving a response to an I/O read request;
setting a fifth count to a second value defined by the second count in response to receiving the response to the I/O read request;
setting a sixth count to a third value defined by the third count in response to receiving the response to the I/O read request;
decrementing the first count in response to incrementing the second count or the third count;
decrementing the second count when the detected coherent write request is acknowledged;
decrementing the third count when the detected non-coherent write request is acknowledged;
decrementing the fourth count in response to decrementing the first count;
decrementing the fifth count in response to decrementing the second count;
incrementing the fifth count if the second count is incremented and while the fourth count is not equal to a first predefined value;
decrementing the sixth count in response to decrementing the third count;
incrementing the sixth count if the third count is incremented and while the fourth count is not equal to the first predefined value; and
transferring the response to the I/O read request to a processing unit that initiated the I/O read request when a sum of the fourth, fifth and sixth counts reaches a second predefined value.

5. The method of claim 4 wherein said first value is equal to said first count, said second value is equal to said second count, and said third value is equal to said third count.

6. The method of claim 4 wherein said first and second predefined values are zero.

7. The method of claim 4 further comprising:
storing the response to the I/O read request in a first buffer; and
storing the response to the I/O read request in a second buffer.

8. The method of claim 7 further comprising:
enabling the fourth, fifth and sixth counts to decrement to a third predefined value before being respectively set to the first, second and third values if a response to a second I/O read request is present in the second buffer when the response to the first I/O read request is stored in the second buffer.

9. The method of claim 8 wherein said third predefined value is zero.

10. The method of claim 4 further comprising:
storing the response to the I/O read request in a first buffer; and
transferring the response to the I/O read request from the first buffer to a processing unit that initiated the I/O read request if a sum of the fourth, fifth and sixth counts is equal to a third predefined value when the response to the I/O read request is stored in the first buffer.

11. The method of claim 10 wherein said third predefined value is zero.

12. A central processing unit comprising:
a first counter configured to increment in response to receiving a write request from an I/O device;
a second counter configured to increment if the write request is detected as being a coherent write request and to decrement when the detected coherent write request is acknowledged, said first counter further configured to decrement in response to incrementing the second counter;
a third counter configured to increment if the write request is detected as being a non-coherent write request and to decrement when the detected non-coherent write request is acknowledged, said first counter further configured to decrement in response to incrementing the third counter;
a fourth counter configured to be set to a first value defined by the first counter's count in response to receiving a response to an I/O read request, said fourth counter configured to decrement in response to decrementing the first counter;
a fifth counter configured to be set to a second value defined by the second counter's count in response to receiving the response to an I/O read request, said fifth counter configured to decrement in response to decrementing the second counter, said fifth counter further configured to increment in response to incrementing the second counter if the fourth counter's count is not equal to a first predefined value;
a sixth counter configured to be set to a third value defined by the second counter's count in response to receiving the response to an I/O read request, said sixth counter configured to decrement in response to decrementing the third counter, said sixth counter further configured to increment in response to incrementing the third counter if the fourth counter's count is not equal to the first predefined value; and
a coherence block configured to transfer the response to the I/O read request to a processing unit that initiated the I/O read request when a sum of the fourth, fifth and sixth counts reaches a second predefined value.

13. The central processing unit of claim 12 wherein said first value is equal to said first counter's count, said second value is equal to said second counter's count, and said third value is equal to said third counter's count.

14. The central processing unit of claim 12 wherein first and second predefined values are zero.

15. The central processing unit of claim 12 further comprising:
a first buffer adapted to store the response to the I/O read request; and
a second buffer adapted to receive and store the response to the I/O read request from the first buffer.

16. The central processing unit of claim 15 wherein said fourth, fifth and sixth counters are decremented to a third predefined value before being respectively set to the first, second and third counters' counts if a response to a second I/O read request is present in the second buffer at the time the response to the first I/O read request is stored in the second buffer.

17. The central processing unit of claim 15 wherein said third predefined value is zero.

18. The central processing unit of claim 12 further comprising:
a first buffer adapted to store the response to the I/O read request; and
a block configured to transfer the response to the I/O read request from the first buffer to a processing unit that initiated the I/O read request if a sum of the counts of the fourth, fifth and sixth counters is equal to a third predefined value when the response to the I/O read request is stored in the first buffer.

19. A central processing unit comprising:
a plurality of processing cores;
an Input/Output (I/O) coherence unit adapted to control coherent traffic between at least one I/O device and the plurality of processing cores; and
a coherence manager adapted to maintain coherence between the plurality of processing cores, said coherence manager comprising:
a request unit configured to receive a coherent request from a first one of the plurality of cores and to selectively issue a speculative request in response;
an intervention unit configured to send an intervention message associated with the coherent request to the plurality of cores;
a memory interface unit configured to receive the speculative request and to selectively forward the speculative request to a memory; and
a response unit configured to supply data associated with the coherent request to the first one of the plurality of cores;
a request mapper adapted to determine whether a received request is a memory-mapped I/O request or a memory request;
a serializer adapted to serialize received requests; and
a serialization arbiter adapted so as not to select a memory mapped input/output request for serialization by the serializer if a memory input/output request serialized earlier by the serializer has not been delivered to the I/O coherence unit.

20. The central processing unit of claim 19 wherein each of the plurality of processing core further comprises:
a core adapted to execute program instructions;
a cache memory adapted to store data in cache lines; and
a cache control logic.

21. A method of handling Input/Output requests in a central processing unit comprising a plurality of processing cores, an Input/Output coherence unit adapted to control coherent traffic between at least one I/O device and the plurality of processing cores, and a coherence manager adapted to maintain coherence between the plurality of processing cores, said method comprising:
identifying whether a first request is a memory-mapped Input/Output request;
serializing the first request;
attempting to deliver the first request to the Input/Output coherence unit if the first request is identified as a memory-mapped Input/Output request;
identifying whether a second request is a memory-mapped Input/Output request; and
disabling serialization of the second request if the second request is identified as being a memory-mapped I/O request and until the first request is received by the Input/Output coherence unit.

22. A computer readable storage medium including instructions defining logic blocks of a microprocessor comprising a plurality of processing cores, the computer readable storage medium adapted for use by an electronic design automation application executed by a computer, wherein the logic blocks are configured to perform an operation comprising:
issuing a non-coherent I/O write request;
stalling the non-coherent I/O write request until prior issued pending coherent I/O write requests are made visible to a plurality of processing cores disposed in the computer system; and
delivering the non-coherent I/O write request to a memory after the prior issued pending coherent I/O write requests are made visible to the plurality of processing cores.

23. A computer readable storage medium including instructions defining logic blocks of a microprocessor comprising a plurality of processing cores, the computer readable storage medium adapted for use by an electronic design automation application executed by a computer, wherein the logic blocks are configured to perform an operation comprising:
incrementing a first count in response to receiving a write request from an I/O device;
incrementing a second count if the write request is detected as being a coherent write request;
incrementing a third count if the write request is detected as being a non-coherent write request;
setting a fourth count to a first value defined by the first count in response to receiving a response to an I/O read request;
setting a fifth count to a second value defined by the second count in response to receiving the response to the I/O read request;
setting a sixth count to a third value defined by the third count in response to receiving the response to the I/O read request;
decrementing the first count in response to incrementing the second count or the third count;
decrementing the second count when the detected coherent write request is acknowledged;
decrementing the third count when the detected non-coherent write request is acknowledged;
decrementing the fourth count in response to decrementing the first count;
decrementing the fifth count in response to decrementing the second count;
incrementing the fifth count if the second count is incremented and while the fourth count is not equal to a first predefined value;
decrementing the sixth count in response to decrementing the third count;
incrementing the sixth count if the third count is incremented and while the fourth count is not equal to the first predefined value; and
transferring the response to the I/O read request to a processing unit that initiated the I/O read request when a sum of the fourth, fifth and sixth counts reaches a second predefined value.

24. A computer readable storage medium including instructions defining logic blocks of a microprocessor comprising a plurality of processing cores, an Input/Output coherence unit adapted to control coherent traffic between at least one I/O device and the plurality of processing cores, and a coherence manager adapted to maintain coherence between the plurality of processing cores, the computer readable storage medium adapted for use by an electronic design automation application executed by a computer, wherein the logic blocks are configured to perform an operation comprising:
identifying whether a first request is a memory-mapped Input/Output request;
serializing the first request;
attempting to deliver the first request to the Input/Output coherence unit if the first request is identified as a memory-mapped Input/Output request;
identifying whether a second request is a memory-mapped Input/Output request; and
disabling serialization of the second request if the second request is identified as being a memory-mapped I/O request and until the first request is received by the Input/Output coherence unit.
